(19) United States
(12) Patent Application Publication
(10) Pub. No.: US 2016/0193960 A1
(43) Pub. Date: Jul. 7, 2016

(54) SYSTEM AND METHOD FOR PROVIDING ALERTS ABOUT A CONDITION OF A CHILD CAR SEAT

(71) Applicant: VOXX INTERNATIONAL CORPORATION, HAUPPAUGE, NY (US)

(72) Inventors: Alfred Barabas, LaHabra, CA (US); Laszlo Barabas, Palos Verdes Penninsula, CA (US); Shane Wilson, Clinton Twp., MI (US)

(21) Appl. No.: 14/982,381

(22) Filed: Dec. 29, 2015

Related U.S. Application Data
(60) Provisional application No. 62/099,329, filed on Jan. 2, 2015.

(51) Int. Cl. B60Q 9/00; B60N 2/00; B60N 2/26

(52) U.S. Cl. CPC B60Q 9/00; B60N 2/26; B60N 2/002

(57) ABSTRACT

A system for alerting a person about a child left in a car seat, the system including: a first unit, wherein the first unit includes a first short-range wireless transceiver; a second unit, wherein the second unit includes a second short-range wireless transceiver, and wherein the first short-range wireless transceiver and the second short-range wireless transceiver pair with each other when they are in a pairing range; and an occupancy sensor, wherein the occupancy sensor is communicably coupled to the second unit, and wherein when the occupancy sensor is disposed on a child car seat that is occupied by a child, and the first unit leaves the pairing range for a predetermined period of time, the first unit signals an alarm.

### CROSS-REFERENCE TO RELATED APPLICATION

This application claims priority under 35 U.S.C. §120 to U.S. provisional application No. 62/099,329, filed Jan. 2, 2015, the disclosure of which is incorporated by reference herein in its entirety.

### TECHNICAL FIELD

The present invention relates to child safety systems, and more particularly, to a system and method for providing alerts about a condition of a child car seat.

### DISCUSSION OF THE RELATED ART

Child car seats are used to protect infants and young children from being injured when a vehicle collides with another object or stops suddenly. Child car seats are typically located in the back seat of a car. Parents can forget a child in the back seat, and caregivers who are not used to driving kids are especially likely to forget. Unfortunately, a child left in a hot car can quickly get too hot and suffer heat stroke, which can lead to high fever, dehydration, seizures, stroke and death.

### SUMMARY OF THE INVENTION

According to an exemplary embodiment of the present invention, there is provided a system for alerting a person about a child left in a car seat, the system comprising: a first unit, wherein the first unit includes a first short-range wireless transceiver; a second unit, wherein the second unit includes a second short-range wireless transceiver, and wherein the first short-range wireless transceiver and the second short-range wireless transceiver pair with each other when they are in a pairing range; and an occupancy sensor, wherein the occupancy sensor is communicably coupled to the second unit, and wherein when the occupancy sensor is disposed on a child car seat that is occupied by a child, and the first unit leaves the pairing range for a predetermined period of time, the first unit signals an alarm.

The first and second short-range wireless transceivers are Bluetooth® transceivers.

The first unit is a keychain tag.

The second unit includes an input port for sensing a state of the occupancy sensor.

The second unit is securable to a frame of the child car seat.

The occupancy sensor is a pressure sensor.

Each of the first and second units includes a button for pairing.

When the first unit returns to the pairing range, the alarm will stop.

When the child is occupying the child car seat, the first and second units become armed, and when the child is not occupying the child car seat, the first and second units become disarmed.

The alarm is audible or vibratory.

According to an exemplary embodiment of the present invention, there is provided a system for alerting a person about a child left in a car seat, the system comprising: a first unit, wherein the first unit includes a first short-range wireless transceiver; a second unit, wherein the second unit includes a second short-range wireless transceiver, and wherein the first short-range wireless transceiver and the second short-range wireless transceiver pair with each other when they are in a pairing range; a third unit, wherein the third unit includes a long-range wireless transceiver; and an occupancy sensor, wherein the occupancy sensor is communicably coupled to the second unit, and wherein when the occupancy sensor is disposed on a child car seat that is occupied by a child, and the first unit leaves the pairing range for a predetermined period of time, the first unit signals an alarm.

The third unit is an original equipment manufacturer device, a smartphone or a control module for a remote start/remote keyless entry system.

When the first unit leaves the pairing range for the predetermined period of time, an alarm condition is provided to the third unit.

The long-range transceiver of the third unit transmits an indication of the alarm condition to a remote device via the internet.

According to an exemplary embodiment of the present invention, there is provided a system for alerting a person about a child left in a car seat, the system comprising: a first unit, wherein the first unit includes a first short-range wireless transceiver and a first long-range wireless transceiver; a second unit, wherein the second unit includes a second short-range wireless transceiver, a temperature sensor and a G-force sensor; and an occupancy sensor, wherein the occupancy sensor is communicably coupled to the second unit, and wherein when the occupancy sensor is disposed on a child car seat that is occupied by a child, and a temperature measured by the temperature sensor exceeds a first preset limit for a first predetermined period of time, or a G-force measured by the G-force sensor exceeds a second preset limit for a second predetermined period of time, the first unit signals an alarm.

The alarm is wirelessly transmitted to a remote device via the long-range transceiver of the first unit.

The remote device is in possession of emergency personnel.

### BRIEF DESCRIPTION OF THE DRAWINGS

FIG. 1 is a block diagram of a system according to an exemplary embodiment of the present invention; and

FIG. 2 is a block diagram of a system according to an exemplary embodiment of the present invention.

### DETAILED DESCRIPTION OF EXEMPLARY EMBODIMENTS

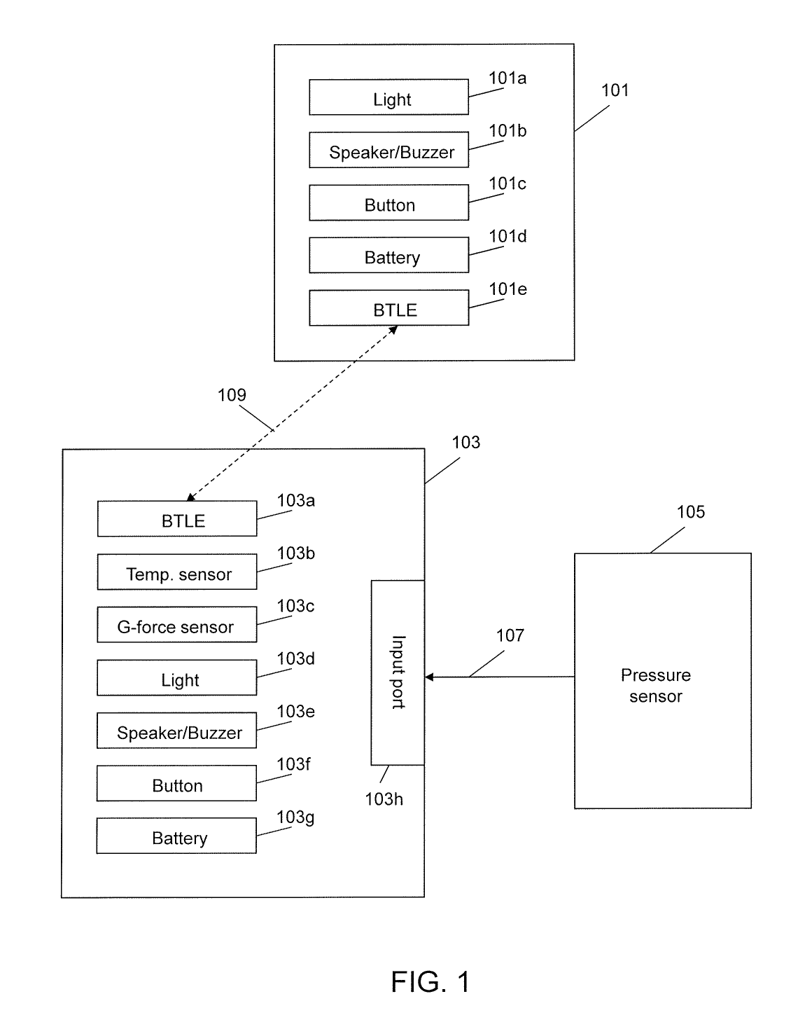

FIG. 1 is a block diagram of a system according to an exemplary embodiment of the present invention.

The system components of FIG. 1 may be installed in a vehicle, and particularly, to a child car seat in a vehicle and the vehicle's keychain. This system may be used to alert the person in possession of the vehicle's keychain that a child has been left in the child car seat when that person has exited the vehicle and traveled beyond a predetermined range.

As shown in FIG. 1, the system includes a first unit 101, a second unit 103 and an occupancy sensor 105. The first unit 101 may be in the form of a keychain tag that can be mounted on a vehicle's keychain. The second unit 103 may be in the form of a weatherproof enclosure with an accessory input port 103h for connection with the occupancy sensor 105.

The first unit 101 may include an LED light 101a, a speaker/buzzer 101b, a button 101c, a battery 101d and a Bluetooth low energy (BTLE) chipset 101e. As an example, the battery 101d may be a single CR2032 battery. The button 101c may be used for pairing and muting the first unit 101.

The second unit 103 may include a BTLE chipset 103a, a temperature sensor 103b, a G-force sensor 103c, an LED light 103d, a speaker/buzzer 103e, a button 103f, a battery 103g and the input port 103h . As an example, the G-force sensor 103c may be an accelerometer. The battery 103g may be two CR2032 batteries. The button 103f may be located on the side of the second unit 103 and used for pairing with the first unit 101. The input port 103h may be connected to the occupancy sensor 105 via connection 107. The connection 107 may be wired. The input port 103h is configured to sense the state of the connected occupancy sensor 105.

The occupancy sensor 105 may be a pressure sensor such as a weight sensor pad. In this case, the occupancy sensor 105 may be placed on a hard surface of a child car seat under its cushion. The occupancy sensor 105 may have a wire for connection to the second unit 103. For example, the wire can be routed out from under the cushion. The second unit 103 may be secured to a seat frame of the child car seat. The wire protruded from the occupancy sensor 105 can be connected to the second unit 103. On the other hand, the second unit 103 may include a wire for connection to the occupancy sensor 105. The occupancy sensor 105 is not limited to a pressure sensor and may include an infrared sensor capable of sensing occupancy of the seat, or a seat belt switch that can be read to determine occupancy.

In an example operation of the system of FIG. 1, the first and second units 101 and 103 may pair with each other when both BTLE chipsets 101e and 103a are within pairing range and the occupancy sensor 105 is on. Reference number 109 indicates the wireless paired connection between the first and second units 101 and 103. If the first unit 101 goes beyond a predetermined range for more than a predetermined period of time, or loses the BT connection for more than the predetermined period of time, the first unit 101 may signal an alarm using its speaker/buzzer 101b.

The pairing range may be set to BT class 2 which is up to 10 meters, for example. The predetermined range may be set to BT class 2, for example. The predetermined time may be set to 5 seconds, for example. All of the listed ranges and times may be variously set. Further, the pairing and predetermined ranges may be different from each other.

When the occupancy sensor 105 is on, the second unit 103 may be armed. The second unit 103 may become disarmed when the occupancy sensor 105 is off. The first unit 101 may enter standby mode when the second unit 103 is disarmed.

In a use case example of the system of FIG. 1, the second unit 103 is mounted on a child car seat. A child sits in this seat. When the child occupies this seat and the first unit 101 is within close proximity, an alarm will not sound from the first unit 101. If the first unit 101 goes outside the proximity or loses connection, the alarm will signal. If the first unit 101 gets back within proximity or connection is regained, the alarm will stop. If the child is no longer occupying the seat, the first unit 101 will disarm and the second unit 103 will disarm. At this point, both units will go on standby.

It is to be understood that additional keychain alarms may be added/paired to the system of FIG. 1. A mobile phone application may also be paired with the system of FIG. 1.

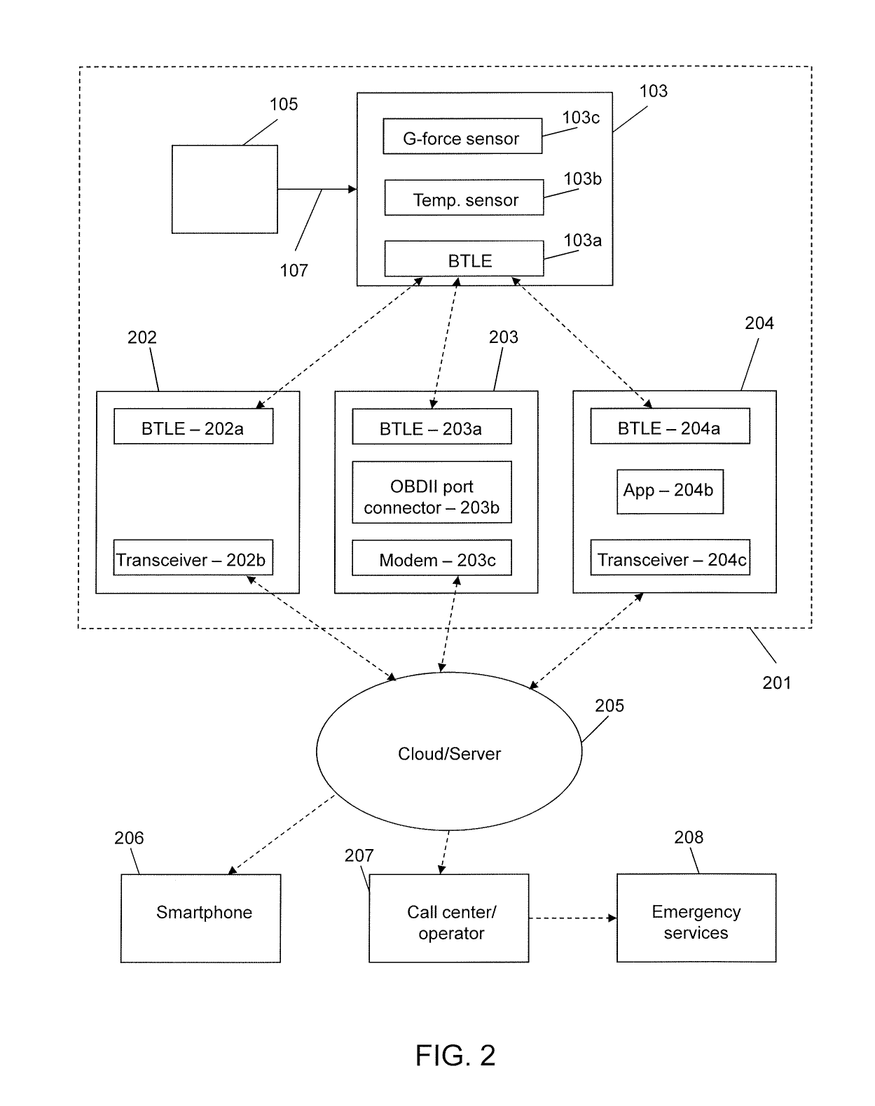

FIG. 2 is a block diagram of a system according to an exemplary embodiment of the present invention.

The system components of FIG. 2 may include the occupancy sensor 105 and the second unit 103 of FIG. 1. In this embodiment, the second unit 103 is shown communicating with other BTLE equipped devices which may be located in a car 201. The other BTLE equipped devices may include an original equipment manufacturer (OEM) device such as an OnStar® module 202, another OEM device such as a Car Connection module 203 manufactured by Audiovox® or a smartphone 204.

It is to be understood that other devices such as a control module for a remote start/remote keyless entry system may be used to communicate with the second unit 103.

The OnStar® module 202 may include a BTLE chipset 202a for wirelessly receiving data from the second unit 103 via a BT link (indicated by the dashed arrow therebetween). The OnStar® module 202 may include a transceiver 202b for performing wireless communication via a cloud or remote server 205.

The Car Connection module 203 may include a BTLE chipset 203a for wirelessly receiving data from the second unit 103 via a BT link (indicated by the dashed arrow therebetween). The Car Connection module 203 may include a connector 203b for connecting to a vehicle's OBDII Port. OBD means on-board diagnostics, which is an automotive term referring to a vehicle's self-diagnostic and reporting capability. The Car Connection module 203 may also include a modem 203c for performing wireless communication via the cloud or remote server 205. The modem 203c may be a transceiver. A description of the features of Car Connection can be found in the document entitled “User Interface Walkthrough” for Car Connection published 2013, the disclosure of which is incorporated by reference herein in its entirety.

The smartphone 204 may include a BTLE chipset 204a for wirelessly receiving data from the second unit 103 via a BT link (indicated by the dashed arrow therebetween). The smartphone 204 may include an application 204b developed to interface with the second unit 103 through the BT link. The smartphone 204 may also include a transceiver 204c for performing wireless communication via the cloud or remote server 205. The application 204b may provide the monitoring feature of the second unit 103. In other words, the smartphone 204 could act as the key tag or first unit 101 of FIG. 1.

The OnStar® module 202, the Car Connection module 203 and the smartphone 204 may wirelessly communicate with the cloud/server 205 (indicated by the dashed arrows therebetween) using Global System for Mobile Communications (GSM) or Long-Term Evolution (LTE), for example. The cloud 205 may refer to the cloud computing model as well as the internet. The server 205 may be a dedicated server used by OnStar® or Car Connection to provide their services. Connected to the cloud/server 205 may be another smartphone 206 and a call center/operator 207. The call center/operator 207 may communicate with emergency services 208.

The system of FIG. 2 may operate like the system of FIG. 1. For example, the BTLE chipsets of the OnStar® module 202, the Car Connection module 203 and the smartphone 204 may pair with the BTLE chipset of the second unit 103 when they are in pairing range. When the first unit 101 of FIG. 1 goes beyond the predetermined range, not only will the alarm of the first unit 101 activate, but the alarm condition will also be communicated to the OnStar® module 202, the Car Connection module 203 and/or the smartphone 204, depending on which is installed in the car 201. Further, as mentioned above, the smartphone 204 may operate as the first unit 101. In this case, if the smartphone 204 goes beyond the predetermined range, the smartphone 204 itself may sound an alarm or vibrate, by virtue of its application 204b. This alarm condition may also be communicated to the OnStar® module 202 and/or the Car Connection module 203.

The following description will center on the Car Connection module 203, but it is to be understood that this description is applicable (in some or all respects) to the OnStar® module 202, the smartphone 204, or a control module for a remote start/remote keyless entry system.

When the aforementioned alarm conditions (e.g., out-of-range and connection lost) are communicated to the Car Connection module 203, the Car Connection module 203 may alert the call center/operator 207 or another smartphone 206 linked with the car 201. This alert may be provided wirelessly through the cloud/server 205. The Car Connection module 203 may also provide this alert to the smartphone 204.

As a use case example, if there is an alert, the Car Connection module 203 may directly alert the smartphones 204 and 206 of that condition. If there is no response, the Car Connection module 203 may alert the call center 207. A response being the operator of the smartphone 204 or 206 deactivating the alarm or confirming that they have received the alert and are checking on the car, for example. The operator 207 may then contact emergency services 208 and inform them that there is an unattended child left in the car 201.

It is to be understood that the aforementioned descriptions have dealt with the situation where a child has been left behind in a car. However, the second unit 103 is equipped with additional sensors such as the G-force sensor 103c. Such a sensor can be used to detect that the vehicle has been involved in an accident. This information when coupled with the information indicative of a child's presence in the car seat can be routed to the proper authorities by virtue of the techniques described above. The knowledge that a child is present in a vehicle, which has been in an accident, can be particularly helpful to emergency service personnel especially before they arrive on the accident scene.

It is to be understood that the temperature sensor 103b found in the second unit 103 can also be used to detect a dangerously high temperature when the child car seat is occupied. For example, if the driver of a car were to become disabled (e.g., has a stroke, passes out, etc.), once the temperature of the car reaches a predetermined high limit and the occupancy sensor 105 indicates there is a child in the car, an alert can be sent. In this case, the alert may go to the driver. If this does not awaken the driver (who is in possession of the first unit 101 or the smartphone 204) and they do not deactivate the alarm, the alert may then be provided to the call center 207. In this case, the operator 207 may contact emergency services 208 and alert them to this dangerous situation. The above scenario is applicable to cases of dangerously low temperatures as well.

It is to be understood that other short range wireless technologies such as near field communication (NFC), ZigBee and radio frequency identification (RFID) may be used in place of BILE to form the device links described above. In addition, the devices may communicate with one another via a BT mesh network protocol. The BT mesh network protocol allows almost an unlimited number of BT smart enabled devices to be networked together and controlled directly from a single smartphone, tablet or PC.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a RAM, a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article or manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical functions(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A system for alerting a person about a child left in a car seat, the system comprising:
a first unit, wherein the first unit includes a first short-range wireless transceiver;
a second unit, wherein the second unit includes a second short-range wireless transceiver, and wherein the first short-range wireless transceiver and the second short-range wireless transceiver pair with each other when they are in a pairing range; and
an occupancy sensor, wherein the occupancy sensor is communicably coupled to the second unit, and wherein when the occupancy sensor is disposed on a child car seat that is occupied by a child, and the first unit leaves the pairing range for a predetermined period of time, the first unit signals an alarm.

2. The system of claim 1, wherein the first and second short-range wireless transceivers are Bluetooth® transceivers.

3. The system of claim 1, wherein the first unit is a keychain tag.

4. The system of claim 1, wherein the second unit includes an input port for sensing a state of the occupancy sensor.

5. The system of claim 1, wherein the second unit is securable to a frame of the child car seat.

6. The system of claim 1, wherein the occupancy sensor is a pressure sensor.

7. The system of claim 1, wherein each of the first and second units includes a button for pairing.

8. The system of claim 1, wherein when the first unit returns to the pairing range, the alarm will stop.

9. The system of claim 1, wherein when the child is occupying the child car seat, the first and second units become armed, and when the child is not occupying the child car seat, the first and second units become disarmed.

10. The system of claim 1, wherein the alarm is audible or vibratory.

11. A system for alerting a person about a child left in a car seat, the system comprising:
a first unit, wherein the first unit includes a first short-range wireless transceiver;
a second unit, wherein the second unit includes a second short-range wireless transceiver, and wherein the first short-range wireless transceiver and the second short-range wireless transceiver pair with each other when they are in a pairing range;
a third unit, wherein the third unit includes a long-range wireless transceiver; and
an occupancy sensor, wherein the occupancy sensor is communicably coupled to the second unit, and wherein when the occupancy sensor is disposed on a child car seat that is occupied by a child, and the first unit leaves the pairing range for a predetermined period of time, the first unit signals an alarm.

12. The system of claim 11, wherein the third unit is an original equipment manufacturer device, a smartphone or a control module for a remote start/remote keyless entry system.

13. The system of claim 11, wherein when the first unit leaves the pairing range for the predetermined period of time, an alarm condition is provided to the third unit.

14. The system of claim 13, wherein the long-range transceiver of the third unit transmits an indication of the alarm condition to a remote device via the internet.

15. A system for alerting a person about a child left in a car seat, the system comprising:
a first unit, wherein the first unit includes a first short-range wireless transceiver and a first long-range wireless transceiver;
a second unit, wherein the second unit includes a second short-range wireless transceiver, a temperature sensor and a G-force sensor; and
an occupancy sensor, wherein the occupancy sensor is communicably coupled to the second unit, and wherein when the occupancy sensor is disposed on a child car seat that is occupied by a child, and a temperature measured by the temperature sensor exceeds a first preset limit for a first predetermined period of time, or a G-force measured by the G-force sensor exceeds a second preset limit for a second predetermined period of time, the first unit signals an alarm.

16. The system of claim 15, wherein the alarm is wirelessly transmitted to a remote device via the long-range transceiver of the first unit.

17. The system of claim 16, wherein the remote device is in possession of emergency personnel.
